(19) United States
(12) Patent Application Publication
(10) Pub. No.: US 2021/0318911 A1
(43) Pub. Date: Oct. 14, 2021

(54) DISTRIBUTED TELEMETRY PLATFORM

(71) Applicants: Joko Banu Sastriawan, Tempe, AZ (US); Ylian Saint-Hilaire, Hillsboro, OR (US); Addicam V. Sanjay, Gilbert, AZ (US); Dominic Rimola, Hillsboro, OR (US)

(72) Inventors: Joko Banu Sastriawan, Tempe, AZ (US); Ylian Saint-Hilaire, Hillsboro, OR (US); Addicam V. Sanjay, Gilbert, AZ (US); Dominic Rimola, Hillsboro, OR (US)

(21) Appl. No.: 17/358,594

(22) Filed: Jun. 25, 2021

(51) Int. Cl. G06F 9/50; G06F 9/455; G06F 9/38; G06F 21/64

(52) U.S. Cl. CPC G06F 9/5038; G06F 9/45508; G06F 21/64; G06F 9/3867; G06F 9/5072

(57) ABSTRACT

System and techniques for distributed telemetry platform are described herein. A telemetry pipeline comprising ordered executable blocks is obtained. Each of these executable blocks including a requirements data structure. A first executable block of the telemetry pipeline is sent to a first agent based on first requirements in the requirements data structure for that executable block. A second executable block of the telemetry pipeline to a second agent based on second requirements in the requirements data structure for the second executable block. The telemetry pipeline is then executed to obtain an indication that the first agent does not meet the first requirements after execution of the telemetry pipeline has begun. In response, the first executable block is moved from the first agent to a third agent.

### TECHNICAL FIELD

Embodiments described herein generally relate to computer monitoring and more specifically to a distributed telemetry platform.

### BACKGROUND

Telemetry in computational systems generally involves capturing measurements of hardware and software use during a workload. Workloads may include running an application, executing specific instructions, performing network calls, etc. Generally, telemetry is performed by data collectors recording available metrics. The metrics may include such this as request queue depths, round-trip processing time, power use, hardware calls, latency, open operating system handles, or other measurable aspects of computer hardware or software. Telemetry analytics are typically performed at data collectors, or consumers of the data produced by telemetry agents. Typically, telemetry agents provide a set (e.g., unchanging) set of measurements that are later consumed by the data collectors and turned into usable analytics.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for distributed telemetry platform, according to an embodiment.

FIG. 2 illustrates an example of component interaction, according to an embodiment.

FIG. 3 illustrates an overview of an edge cloud configuration for edge computing.

FIG. 4 illustrates operational layers among endpoints, an edge cloud, and cloud computing environments.

FIG. 5 illustrates an example approach for networking and services in an edge computing system.

FIG. 6 illustrates deployment of a virtual edge configuration in an edge computing system operated among multiple edge nodes and multiple tenants.

FIG. 7 illustrates various compute arrangements deploying containers in an edge computing system.

FIG. 8A provides an overview of example components for compute deployed at a compute node in an edge computing system.

FIG. 8B provides a further overview of example components within a computing device in an edge computing system.

FIG. 9 illustrates an example software distribution platform to distribute software.

FIG. 10 illustrates a flow diagram of an example of a method for distributed telemetry platform, according to an embodiment.

FIG. 11 is a block diagram illustrating an example of a machine upon which one or more embodiments may be implemented.

### DETAILED DESCRIPTION

As the workload profiles and corresponding metrics change, adapting telemetry analytics to support workload orchestration becomes very challenging. The availability of platform monitoring technology telemetry on some hardware platforms enables data collection and analytics at the firmware level rather than by an operating system agent. However, there are a few issues with current telemetry approaches. For example, typical approaches use basic agent statistical analytics. Here, agents perform statistical analytics (e.g., mean, max, min, etc.) on the data at the agent. These agents typically perform predefined threshold-based alerting for immediate feedback Generally. These agent analytics are static, rigid, and unable to scale to address complex analytics across multiple entities (e.g., other agents and collectors).

To address the issues a common agent runtime is implemented across various platform layers, such as in firmware, at the operating system (OS), and in the cloud. The runtime enables flexible telemetry pipelines to be run. Here, the pipeline comprises several executable blocks that will execute on the runtime without regard to the location (e.g., in firmware, the cloud, etc.) of the execution. However, a given location may lack the computing resources to execute a particular executable block at any given moment. Here, the executable block may be moved to another location. In an example, the executable block is adjustable based on the location. For example, a sampling rate may be reduced to enabled a, usually, more computationally constrained firmware location to execute the block.

The runtime is a portable telemetry analytics environment that enables a telemetry workload to be redistributed based on the runtime constraints and a dynamically defined policy. This approach results in several advantages. For example, telemetry analytics may be defined once and to run on different types of entities—such as in-band agents (e.g., in the OS), out of band agents (e.g., in hardware or firmware), or telemetry collectors (e.g., in remote or cloud nodes). Further, the approach prevents telemetry workloads from overwhelming the runtime environment by enforcing the runtime constraints. Additionally, efficiency and runtime resources use are maximized by using a policy to deploy telemetry analytics to the best fitting environments, such as those with the most useful hardware accelerators or advanced telemetry algorithm support.

In an example, the telemetry agents (in-band and out-of-band) and data collectors contain a shared runtime environment to execute portable analytics blocks. Thus, telemetry agents and collectors may execute the same algorithm based on the code (e.g., source code, bytecodes, object code, scripts, etc.) inside the shared runtime environment. In an example, the shared runtime exposes capabilities of the execution environment and standard environment interfaces. The shared runtime also enforces constraints, such as limiting the analytics execution in term of memory, a computational bound, or resources access bound. In an example, these policies and constraints may be dynamically defined.

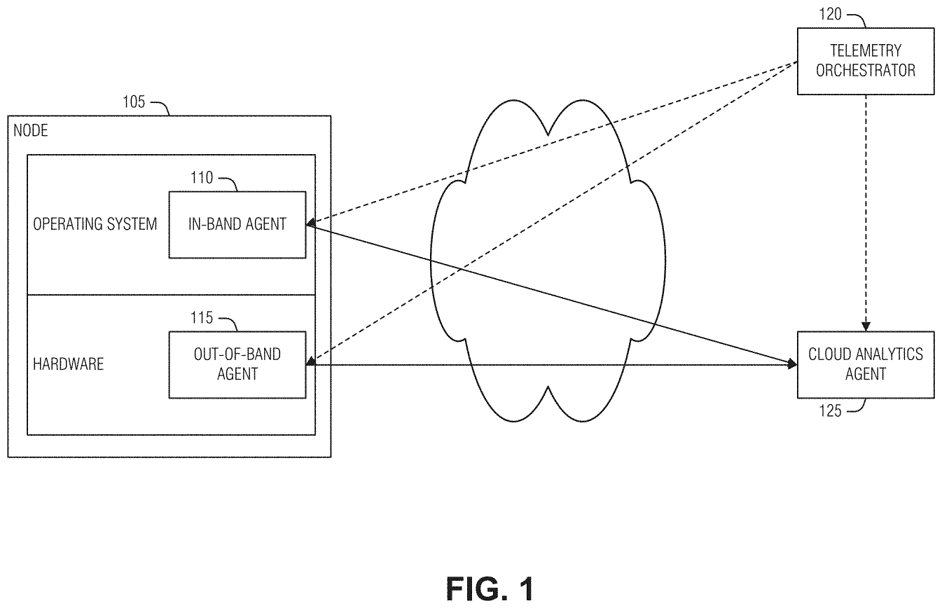

FIG. 1 is a block diagram of an example of an environment including a system for distributed telemetry platform, according to an embodiment. As illustrated, a node 105 includes an in-band (TB) agent 110 in the OS and an out-of-band (OOB) agent 115. A cloud analytics agent 125 (e.g., a collector) is communicatively coupled to the IB agent 110 or the OOB agent 115 when in operation. Each of the 113 agent 110, the OOB agent 115, and the cloud analytics agent 120 use a common runtime. The telemetry orchestrator 120 runs telemetry pipelines on the agents by distributing executable blocks to the agents.

The three subsystems—the IB agent 110, the OOB agent 115, and the cloud analytics agent 125—are working in unison to run parts or complete operations of telemetry. The three subsystems may off-load parts of analytics to each other using the same cryptographically signed data analytics executable blocks that make up a telemetry pipeline.

The IB agent 110 may include data collection and analytics software running on top of the OS or a hypervisor. The OOB agent 115 may include data collection and analytics software running inside embedded firmware within a computing platform such as a manageability engine, embedded controller, or programmable service engine.

The following is an example of telemetry pipeline workload orchestration. An OOB agent 115 may be running and performing raw counters or samples data collection through hardware telemetry interfaces. The OOB agent 115 may also run a data cleaning procedure and then provide the IB agent 110 and the cloud analytics agent 125 with processed telemetry data.

The IB agent 115 may consume the processed telemetry data and execute a second data analytics procedure for a direct workload scheduler. The cloud analytics agent 125 may consumes the processed telemetry data and further trend analysis or machine learning on the data for longer term purposes, such as workload profiling, workload migration, or orchestration.

The executable code blocks, such as the data cleaning procedure, the data analytics for immediate scheduler, or the trend analysis for machine learning are trusted, portable, code. Accordingly, the same analytic code running on the OOB agent 115 may be deployed on the IB agent 110. The architecture enables the same telemetry executable code to run without modification across the different runtime environments. This enables the telemetry orchestrator 120 to shift the computation of different parts of the telemetry pipeline based on the resources available of the environment and the requirements of the executable code block.

To enable coordinated deployment of executable code blocks of a telemetry pipeline on all three environments, one or more of the following architectural features may be implemented:

1. The agents are trusted, as is the communication between the agents and the telemetry orchestrator 120.

2. A secure failsafe code deployment, mechanism is employed.

3. Each agent includes the portable runtime environment.

4. A common data format is used for storage and exchanges.

5. The runtime exposes an accelerator (e.g., GPU, HDDL, FPGA, etc.) application programming interface (API) when available.

6. The executable blocks may be signed using a signing trust model.

7. Execution policies may limit the resources consumable by the executable block.

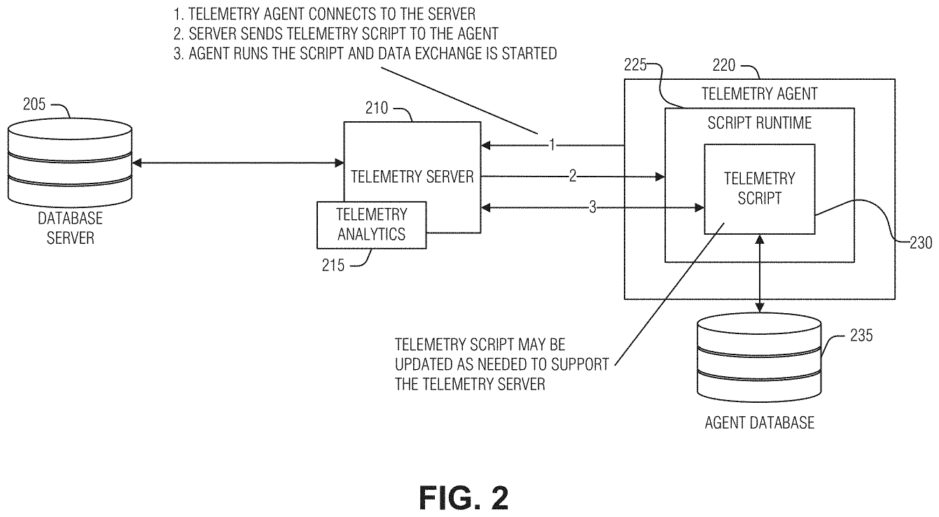

FIG. 2 illustrates an example of component interaction, according to an embodiment. The telemetry agent 220 may be run on many remote devices that connect back and authenticate to a trusted telemetry server 210, for example, on the internet. The telemetry server 210 may then push JavaScript code 230 to the agent 220. The code 230 is then run in the runtime 225 on the agent 220 to collect data (e.g., in the agent database 235), perform analysis of the data, and send relevant information to the server 210 for central processing (e.g., the telemetry analytics 215 for storage with the database server 205).

At any time, the telemetry server 210 may instruct the agent 220 to stop running the JavaScript code 230 or replace the code 230 with new code. The telemetry server 210 may also serve different JavaScript code to different agents to best adapt the code to the agent's specific capabilities or for A/B testing.

The JavaScript code 230 is run by the agent within the runtime environment 225. This embodiment has the additional benefit that, when paired with a server written in NodeJS, JavaScript Object Notation (JSON) is a good choice for a data transport and storage format. Thus, the telemetry data may be corrected by the JavaScript code 230 and uploaded using JSON. In an example, a load database 235 may be used to store some local data as dictated by the JavaScript code 230. This local database 235 may be used to enhance local data processing across device reboots or enable the agent 220 to aggregate telemetry data of lower priority and send this data to the server 210 in bulk when needed.

Another advantage of this architecture is realized by running the telemetry server 210 on a low resource (e.g., low power, no accelerator, etc.) machine. Here, the processing power of the agents—including GPUs FPGAs, etc.—may be used to perform more complex processing on the data. In this scenario the server 210 may send the agent 220 a more complex telemetry script 230 and data to be processed. In an example, a neural network may be implemented on an idle GPU on the agent 220 to process data sent to the agent 220. Many such agents may be used to perform these tasks. In an example, some of the processing of data may overlap to validate that agents are returning consistent results.

In an example, in order to safe-guard security, the portable runtime 225 may only expose high-level runtime interfaces based on an execution policy. In an example, the portable runtime 225 may allow trusted or cryptographically signed executable blocks to run. The security scope controlled by the execution policy may include network access, accelerator access, compute performance limits, storage access, or allocated memory, among others.

In an example, If the runtime environment 225 cannot meet the execution requirements of the executable block, or the executable block resource use during execution exceed an allowed limit as defined by its deployment policy, the server 210 may take action to degrade the executable block's execution to meet the imposed limits or constraints, to migrate the executable block to another available runtime environment, or to terminate the execution of the executable block.

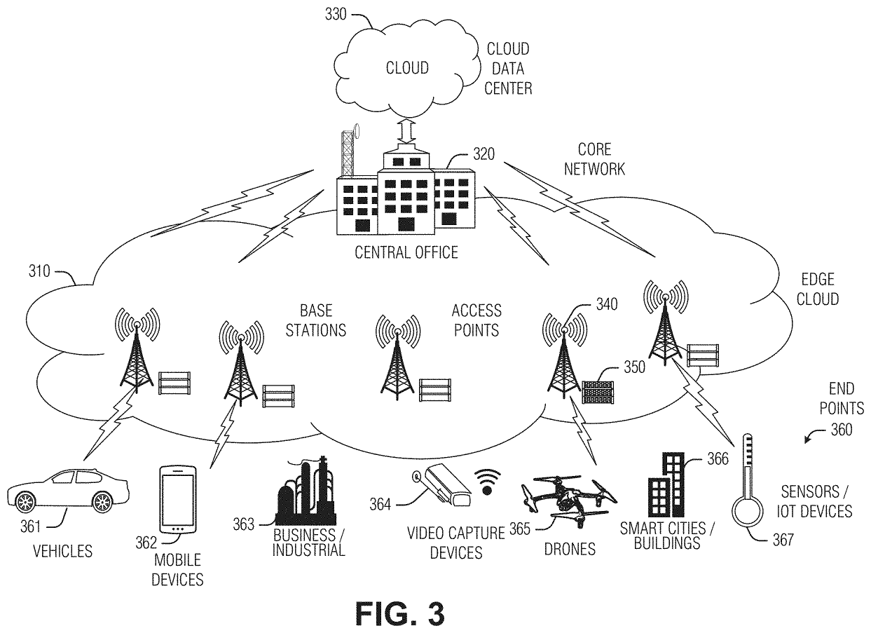

FIG. 3 is a block diagram showing an overview of a configuration for edge computing, which includes a layer of processing referred to in many of the following examples as an “edge cloud”. As shown, the edge cloud 310 is co-located at an edge location, such as an access point or base station 340, a local processing hub 350, or a central office 320, and thus may include multiple entities, devices, and equipment instances. The edge cloud 310 is located much closer to the endpoint (consumer and producer) data sources 360 (e.g., autonomous vehicles 361, user equipment 362, business and industrial equipment 363, video capture devices 364, drones 365, smart cities and building devices 366, sensors and IoT devices 367, etc.) than the cloud data center 330. Compute, memory, and storage resources which are offered at the edges in the edge cloud 310 are critical to providing ultra-low latency response times for services and functions used by the endpoint data sources 360 as well as reduce network backhaul traffic from the edge cloud 310 toward cloud data center 330 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

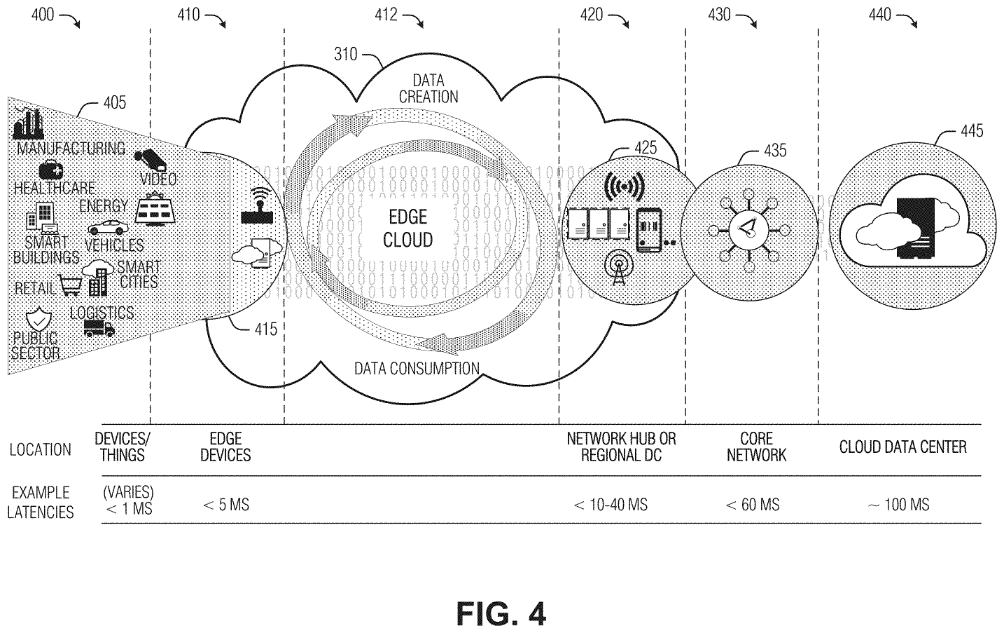

FIG. 4 illustrates operational layers among endpoints, an edge cloud, and cloud computing environments. Specifically, FIG. 4 depicts examples of computational use cases 405, utilizing the edge cloud 310 among multiple illustrative layers of network computing. The layers begin at an endpoint (devices and things) layer 400, which accesses the edge cloud 310 to conduct data creation, analysis, and data consumption activities. The edge cloud 310 may span multiple network layers, such as an edge devices layer 410 having gateways, on-premise servers, or network equipment (nodes 415) located in physically proximate edge systems; a network access layer 420, encompassing base stations, radio processing units, network hubs, regional data centers (DC), or local network equipment (equipment 425); and any equipment, devices, or nodes located therebetween (in layer 412, not illustrated in detail). The network communications within the edge cloud 310 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 400, under 5 ms at the edge devices layer 410, to even between 10 to 40 ms when communicating with nodes at the network access layer 420. Beyond the edge cloud 310 are core network 430 and cloud data center 440 layers, each with increasing latency (e.g., between 50-60 ms at the core network layer 430, to 100 or more ms at the cloud data center layer). As a result, operations at a core network data center 435 or a cloud data center 445, with latencies of at least 50 to 100 ms or more, will not be able to accomplish many time-critical functions of the use cases 405. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 435 or a cloud data center 445, a central office or content data network may be considered as being located within a “near edge” layer (“near” to the cloud, having high latency values when communicating with the devices and endpoints of the use cases 405), whereas an access point, base station, on-premise server, or network gateway may be considered as located within a “far edge” layer (“far” from the cloud, having low latency values when communicating with the devices and endpoints of the use cases 405). It will be understood that other categorizations of a particular network layer as constituting a “close”, “local”, “near”, “middle”, or “far” edge may be based on latency, distance, number of network hops, or other measurable characteristics, as measured from a source in any of the network layers 400-440.

The various use cases 405 may access resources under usage pressure from incoming streams, due to multiple services utilizing the edge cloud. To achieve results with low latency, the services executed within the edge cloud 310 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 310 may provide the ability to serve and respond to multiple applications of the use cases 405 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 310 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 310 (network layers 400-440), which provide coordination from client and distributed computing devices, One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 310.

As such, the edge cloud 310 is formed from network components and functional features operated by and within edge gateway nodes, edge aggregation nodes, or other edge compute nodes among network layers 410-430. The edge cloud 310 thus may be embodied as any type of network that provides edge computing or storage resources which are proximately located to radio access network (RAN) capable endpoint devices (e.g., mobile computing devices, IoT devices, smart devices, etc.), which are discussed herein. In other words, the edge cloud 310 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage or compute capabilities. Other types and forms of network access (e.g., Wi-Fi, long-range wireless, wired networks including optical networks) may also be utilized in place of or in combination with such 3GPP carrier networks.

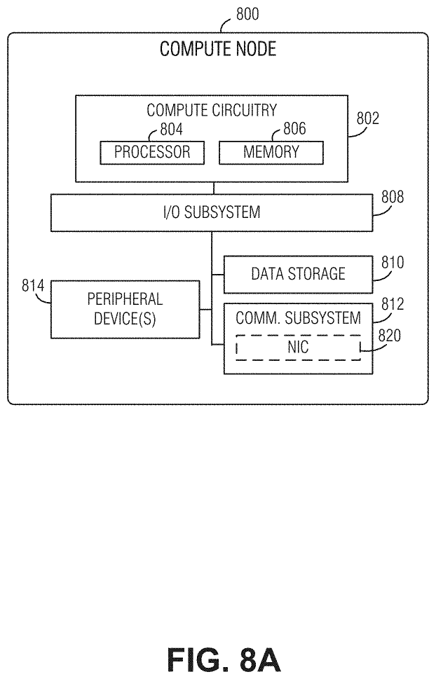

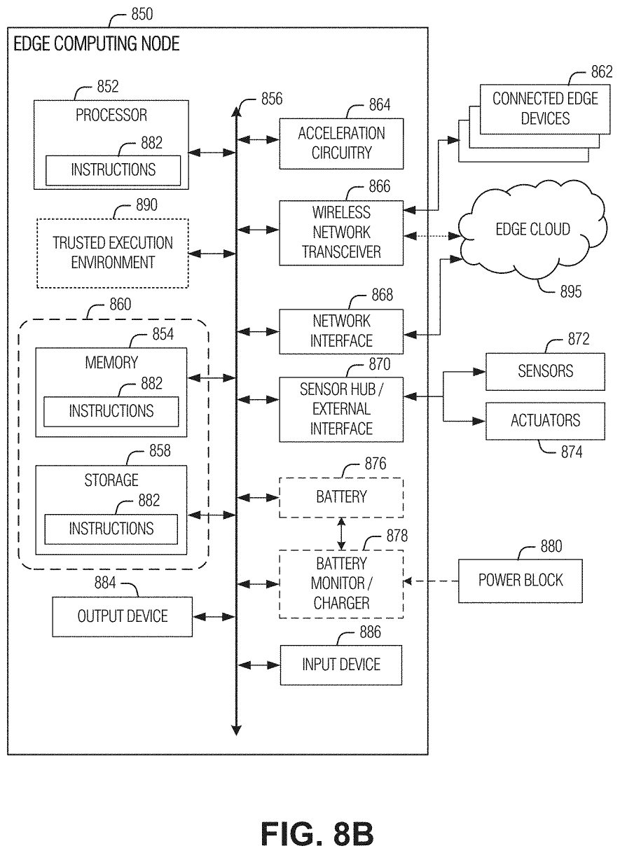

The network components of the edge cloud 310 may be servers, multi-tenant servers, appliance computing devices, or any other type of computing devices. For example, the edge cloud 310 may include an appliance computing device that is a self-contained electronic device including a housing, a chassis, a case, or a shell. In some circumstances, the housing may be dimensioned for portability such that it can be carried by a human or shipped. Example housings may include materials that form one or more exterior surfaces that partially or fully protect contents of the appliance, in which protection may include weather protection, hazardous environment protection (e.g., EMI, vibration, extreme temperatures), or enable submergibility. Example housings may include power circuitry to provide power for stationary or portable implementations, such as AC power inputs, DC power inputs, AC/DC or DC/AC converter(s), power regulators, transformers, charging circuitry, batteries, wired inputs or wireless power inputs. Example housings or surfaces thereof may include or connect to mounting hardware to enable attachment to structures such as buildings, telecommunication structures (e.g., poles, antenna structures, etc.) or racks (e.g., server racks, blade mounts, etc.). Example housings or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface or mounted to the surface of the appliance. Example housings or surfaces thereof may support mechanical connectivity, such as propulsion hardware (e.g., wheels, propellers, etc.) or articulating hardware (e.g., robot arms, pivotable appendages, etc.), in some circumstances, the sensors may include any type of input devices such as user interface hardware (e.g., buttons, switches, dials, sliders, etc.). In some circumstances, example housings include output devices contained in, carried by, embedded therein or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 8B. The edge cloud 310 may also include one or more servers or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications or other software, code or scripts may execute while being isolated from one or more other applications, software, code, or scripts.

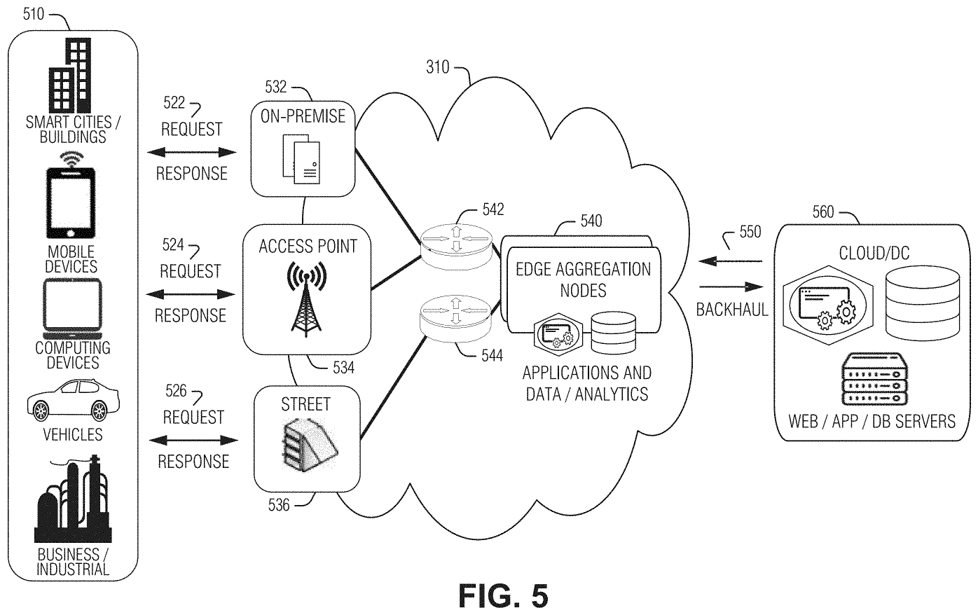

In FIG. 5, various client endpoints 510 (in the form of mobile devices, computers, autonomous vehicles, business computing equipment, industrial processing equipment) exchange requests and responses that are specific to the type of endpoint network aggregation. For instance, client endpoints 510 may obtain network access via a wired broadband network, by exchanging requests and responses 522 through an on-premise network system 532. Some client endpoints 510, such as mobile computing devices, may obtain network access via a wireless broadband network, by exchanging requests and responses 524 through an access point (e.g., cellular network tower) 534. Some client endpoints 510, such as autonomous vehicles may obtain network access for requests and responses 526 via a wireless vehicular network through a street-located network system 536. However, regardless of the type of network access, the TSP may deploy aggregation points 542, 544 within the edge cloud 310 to aggregate traffic and requests. Thus, within the edge cloud 310, the TSP may deploy various compute and storage resources, such as at edge aggregation nodes 540, to provide requested content. The edge aggregation nodes 540 and other systems of the edge cloud 310 are connected to a cloud or data center 560, which uses a backhaul network 550 to fulfill higher-latency requests from a cloud/data center for websites, applications, database servers, etc. Additional or consolidated instances of the edge aggregation nodes 540 and the aggregation points 542, 544, including those deployed on a single server framework, may also be present within the edge cloud 310 or other areas of the TSP infrastructure.

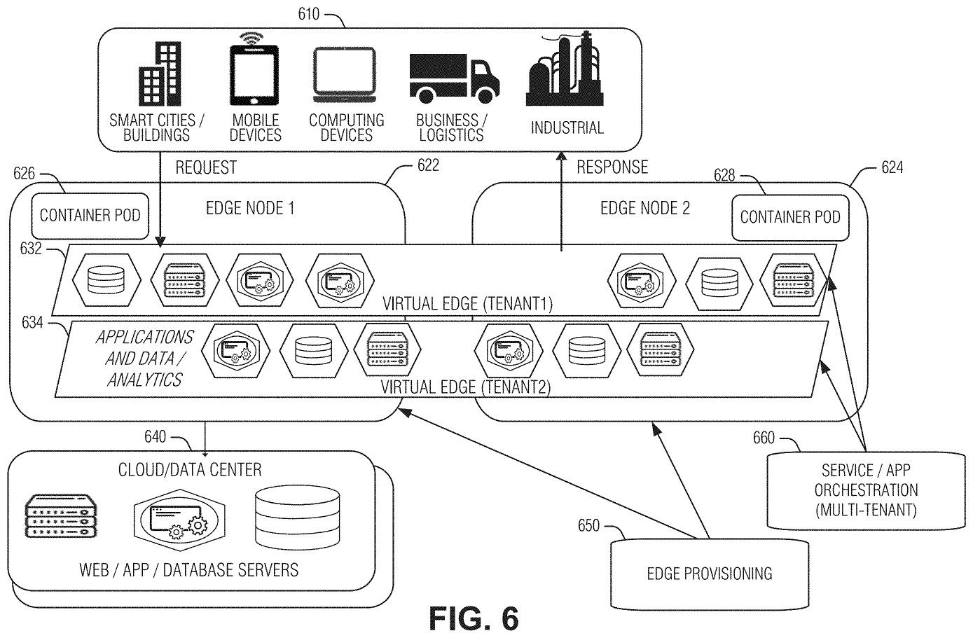

FIG. 6 illustrates deployment, and orchestration for virtualized and container-based edge configurations across an edge computing system operated among multiple edge nodes and multiple tenants (e.g., users, providers) which use such edge nodes. Specifically, FIG. 6 depicts coordination of a first edge node 622 and a second edge node 624 in an edge computing system, to fulfill requests and responses for various client endpoints 610 (e.g., smart cities/building systems, mobile devices, computing devices, business/logistics systems, industrial systems, etc.), which access various virtual edge instances. Here, the virtual edge instances 632, 634 provide edge compute capabilities and processing in an edge cloud, with access to a cloud/data center 640 for higher-latency requests for websites, applications, database servers, etc. However, the edge cloud enables coordination of processing among multiple edge nodes for multiple tenants or entities.

In the example of FIG. 6, these virtual edge instances include: a first virtual edge 632, offered to a first tenant (Tenant 1), which offers a first combination of edge storage, computing, and services; and a second virtual edge 634, offering a second combination of edge storage, computing, and services. The virtual edge instances 632, 634 are distributed among the edge nodes 622, 624, and may include scenarios in which a request and response are fulfilled from the same or different edge nodes. The configuration of the edge nodes 622, 624 to operate in a distributed yet coordinated fashion occurs based on edge provisioning functions 650. The functionality of the edge nodes 622, 624 to provide coordinated operation for applications and services, among multiple tenants, occurs based on orchestration functions 660.

It should be understood that some of the devices in 610 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 622, 624 may operate as security feature enforcement points for local resources allocated to multiple tenants per node. Additionally, tenant runtime and application execution (e.g., in instances 632, 634) may serve as an enforcement point for a security feature that creates a virtual edge abstraction of resources spanning potentially multiple physical hosting platforms. Finally, the orchestration functions 660 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, Servlets, servers, or other computation abstraction that may be partitioned according to a DICE layering and fan-out structure to support a RoT context for each. Accordingly, the respective RoTs spanning devices 610, 622, and 640 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 6. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 622, 624 may implement the use of containers, such as with the use of a container “pod” 626, 628 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 632, 634 are partitioned according to the needs of each container.

With the use of container pods, a pod controller oversees the partitioning and allocation of containers and resources. The pod controller receives instructions from an orchestrator (e.g., orchestrator 660) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 660 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute, and a different shared pod controller is installed and invoked prior to the second pod executing.

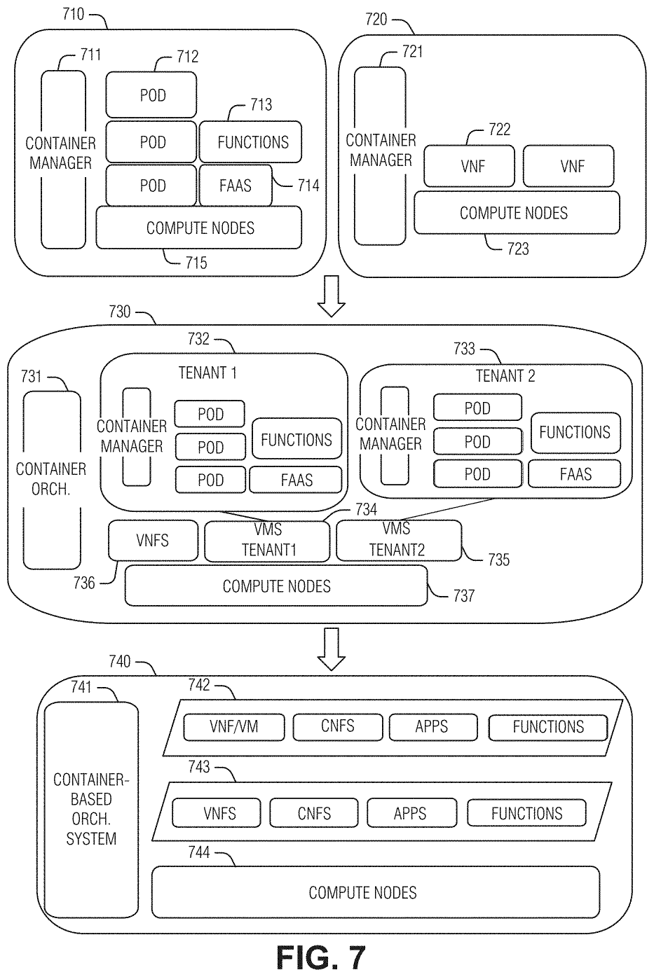

FIG. 7 illustrates additional compute arrangements deploying containers in an edge computing system. As a simplified example, system arrangements 710, 720 depict settings in which a pod controller (e.g., container managers 711, 721, and container orchestrator 731) is adapted to launch containerized pods, functions, and functions-as-a-service instances through execution via compute nodes (715 in arrangement 710), or to separately execute containerized virtualized network functions through execution via compute nodes (723 in arrangement 720). This arrangement is adapted for use of multiple tenants in system arrangement 730 (using compute nodes 737), where containerized pods (e.g., pods 712), functions (e.g., functions 713, VNFs 722, 736), and functions-as-a-service instances (e.g., FaaS instance 714) are launched within virtual machines (e.g., VMs 734, 735 for tenants 732, 733) specific to respective tenants (aside the execution of virtualized network functions). This arrangement is further adapted for use in system arrangement 740, which provides containers 742, 743, or execution of the various functions, applications, and functions on compute nodes 744, as coordinated by an container-based orchestration system 741.

The system arrangements of depicted in FIG. 7 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 7, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves, and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon (SDSi) may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

In further examples, any of the compute nodes or devices discussed with reference to the present edge computing systems and environment may be fulfilled based on the components depicted in FIGS. 8A and 8B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 8A, an edge compute node 800 includes a compute engine (also referred to herein as “compute circuitry”) 802, an input/output (I/O) subsystem 808, data storage 810, a communication circuitry subsystem 812, and, optionally, one or more peripheral devices 814. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 800 may be embodied as an type of engine, device, or collection of devices capable of performing various compute functions. In some examples, the compute node 800 may be embodied as a single device such as an integrated circuit, an embedded system, a field-programmable gate array (FPGA), a system-on-a-chip (SOC), or other integrated system or device. In the illustrative example, the compute node 800 includes or is embodied as a processor 804 and a memory 806. The processor 804 may be embodied as any type of processor capable of performing the functions described herein (e.g., executing an application). For example, the processor 804 may be embodied as a multi-core processor(s), a microcontroller, a processing unit, a specialized or special purpose processing unit, or other processor or processing/controlling circuit.

In some examples, the processor 804 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 804 may work in coordination with each other to execute many types of operations and instructions within and on behalf of the compute node 800.

The memory 806 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 806 may be integrated into the processor 804. The memory 806 may store various software and data used during operation such as one or more applications, data operated on by the application(s), libraries, and drivers.

The compute circuitry 802 is communicatively coupled to other components of the compute node 800 via the I/O subsystem 808, which may be embodied as circuitry or components to facilitate input/output operations with the compute circuitry 802 (e.g., with the processor 804 or the main memory 806) and other components of the compute circuitry 802. For example, the I/O subsystem 808 may be embodied as, or otherwise include, memory controller hubs, input/output control hubs, integrated sensor hubs, firmware devices, communication links (e.g., point-to-point links, bus links, wires, cables, light guides, printed circuit board traces, etc.), or other components and subsystems to facilitate the input/output operations. In some examples, the I/O subsystem 808 may form a portion of a system-on-a-chip (SoC) and be incorporated, along with one or more of the processor 804, the memory 806, and other components of the compute circuitry 802, into the compute circuitry 802.

The one or more illustrative data storage devices 810 may be embodied as any type of devices configured for short-term or long-term storage of data such as, for example, memory devices and circuits, memory cards, hard disk drives, solid-state drives, or other data storage devices. Individual data storage devices 810 may include a system partition that stores data and firmware code for the data storage device 810. Individual data storage devices 810 may also include one or more operating system partitions that store data files and executables for operating systems depending on, for example, the type of compute node 800.

The communication circuitry 812 may be embodied as any communication circuit, device, or collection thereof, capable of enabling communications over a network between the compute circuitry 802 and another compute device (e.g., an edge gateway of an implementing edge computing system). The communication circuitry 812 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 812 includes a network interface controller (NIC) 820, which may also be referred to as a host fabric interface (HFI). The NIC 820 may be embodied as one or more add-in-boards, daughter cards, network interface cards, controller chips, chipsets, or other devices that may be used by the compute node 800 to connect with another compute device (e.g., an edge gateway node). In some examples, the NIC 820 may be embodied as part of a system-on-a-chip (SoC) that includes one or more processors, or included on a multichip package that also contains one or more processors. In some examples, the NIC 820 may include a local processor (not shown) or a local memory (not shown) that are both local to the NIC 820. In such examples, the local processor of the NIC 820 may be capable of performing one or more of the functions of the compute circuitry 802 described herein. Additionally, or alternatively, in such examples, the local memory of the NIC 820 may be integrated into one or more components of the client compute node at the board level, socket level, chip level, or other levels.

Additionally, in some examples, a respective compute node 800 may include one or more peripheral devices 814. Such peripheral devices 814 may include any type of peripheral device found in a compute device or server such as audio input devices, a display, other input/output devices, interface devices, or other peripheral devices, depending on the particular type of the compute node 800. In further examples, the compute node 800 may be embodied by a respective edge compute node (whether a client, gateway, or aggregation node) in an edge computing system or like forms of appliances, computers, subsystems, circuitry, or other components.

In a more detailed example, FIG. 8B illustrates a block diagram of an example of components that may be present in an edge computing node 850 for implementing the techniques (e.g., operations, processes, methods, and methodologies) described herein. This edge computing node 850 provides a closer view of the respective components of node 800 when implemented as or as part of a computing device (e.g., as a mobile device, a base station, server, gateway, etc.). The edge computing node 850 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 850, or as components otherwise incorporated within a chassis of a larger system.

The edge computing device 850 may include processing circuitry in the form of a processor 852, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 852 may be a part of a system on a chip (SoC) in which the processor 852 and other components are formed into a single integrated circuit, or a single package, such as the Edison™ or Galileo™ SoC boards from Intel Corporation, Santa Clara, Calif. As an example, the processor 852 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple@ Inc., a Snapdragon™ processor from Qualcomm® Technologies, Inc., or an OMAP™ processor from Texas Instruments, Inc. The processor 852 and accompanying circuitry may be provided in a single socket form factor, multiple socket form factor, or a variety of other formats, including in limited hardware configurations or configurations that include fewer than all elements shown in FIG. 8B.

The processor 852 may communicate with a system memory 854 over an interconnect 856 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 858 may also couple to the processor 852 via the interconnect 856. In an example, the storage 858 may be implemented via a solid-state disk drive (SSDD). Other devices that may be used for the storage 858 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 858 may be on-die memory or registers associated with the processor 852. However, in some examples, the storage 858 may be implemented using a micro hard disk drive (HDD). Further, any number of new technologies may be used for the storage 858 in addition to, or instead of, the technologies described, such resistance change memories, phase change memories, holographic memories, or chemical memories, among others.

The components may communicate over the interconnect 856. The interconnect 856 may include any number of technologies, including industry standard architecture (ISA), extended ISA (EISA), peripheral component interconnect (PCI), peripheral component interconnect extended (PCIx), PCI express (PCIe), or any number of other technologies. The interconnect 856 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 856 may couple the processor 852 to a transceiver 866, for communications with the connected edge devices 862. The transceiver 866 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 862. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 866 (or multiple transceivers) may communicate using multiple standards or radios for communications at a different range. For example, the edge computing node 850 may communicate with close devices, e.g., within about 10 meters, using a local transceiver based on Bluetooth Low Energy (BLE), or another low power radio, to save power. More distant connected edge devices 862, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 866 (e.g., a radio transceiver) may be included to communicate with devices or services in a cloud (e.g., an edge cloud 895) via local or wide area network protocols. The wireless network transceiver 866 may be a low-power wide-area (LPWA) transceiver that follows the IEEE 802.15.4, or IEEE 802.15.4g standards, among others. The edge computing node 850 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 866, as described herein. For example, the transceiver 866 may include a cellular transceiver that uses spread spectrum (SPA/SAS) communications for implementing high-speed communications. Further, any number of other protocols may be used, such as Wi-Fi® networks for medium speed communications and provision of network communications. The transceiver 866 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 868 may be included to provide a wired communication to nodes of the edge cloud 895 or to other devices, such as the connected edge devices 862 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 868 may be included to enable connecting to a second network, for example, a first NIC 868 providing communications to the cloud over Ethernet, and a second NIC 868 providing communications to other devices over another type of network.

Given the variety of types of applicable communications from the device to another component or network, applicable communications circuitry used by the device may include or be embodied by any one or more of components 864, 866, 868, or 870. Accordingly, in various examples, applicable means for communicating (e.g., receiving, transmitting, etc.) may be embodied by such communications circuitry.

The edge computing node 850 may include or be coupled to acceleration circuitry 864, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 856 may couple the processor 852 to a sensor hub or external interface 870 that is used to connect additional devices or subsystems. The devices may include sensors 872, such as accelerometers, level sensors, flow sensors, optical light sensors, camera sensors, temperature sensors, global navigation system (e.g., GPS) sensors, pressure sensors, barometric pressure sensors, and the like. The hub or interface 870 further may be used to connect the edge computing node 850 to actuators 874, such as power switches, valve actuators, an audible sound generator, a visual warning device, and the like.

In some optional examples, various input/output (I/O) devices may be present within or connected to, the edge computing node 850. For example, a display or other output device 884 may be included to show information, such as sensor readings or actuator position. An input device 886, such as a touch screen or keypad may be included to accept input. An output device 884 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 850. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 876 may power the edge computing node 850, although, in examples in which the edge computing node 850 is mounted in a fixed location, it may have a power supply coupled to an electrical grid, or the battery may be used as a backup or for temporary capabilities. The battery 876 may be a lithium ion battery, or a metal-air battery, such as a zinc-air battery, an aluminum-air battery, a lithium-air battery, and the like.

A battery monitor/charger 878 may be included in the edge computing node 850 to track the state of charge (SoCh) of the battery 876, if included. The battery monitor/charger 878 may be used to monitor other parameters of the battery 876 to provide failure predictions, such as the state of health (SoH) and the state of function (SoF) of the battery 876. The battery monitor/charger 878 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 878 may communicate the information on the battery 876 to the processor 852 over the interconnect 856. The battery monitor/charger 878 may also include an analog-to-digital (ADC) converter that enables the processor 852 to directly monitor the voltage of the battery 876 or the current flow from the battery 876. The battery parameters may be used to determine actions that the edge computing node 850 may perform, such as transmission frequency, mesh network operation, sensing frequency, and the like.

A power block 880, or other power supply coupled to a grid, may be coupled with the battery monitor/charger 878 to charge the battery 876. In some examples, the power block 880 may be replaced with a wireless power receiver to obtain the power wirelessly, for example, through a loop antenna in the edge computing node 850. A wireless battery charging circuit, such as an LTC4020 chip from Linear Technologies of Milpitas, Calif., among others, may be included in the battery monitor/charger 878. The specific charging circuits may be selected based on the size of the battery 876, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 858 may include instructions 882 in the form of software, firmware, or hardware commands to implement the techniques described herein. Although such instructions 882 are shown as code blocks included in the memory 854 and the storage 858, it may be understood that any of the code blocks may be replaced with hardwired circuits, for example, built into an application specific integrated circuit (ASIC).

In an example, the instructions 882 provided via the memory 854, the storage 858, or the processor 852 may be embodied as a non-transitory, machine-readable medium 860 including code to direct the processor 852 to perform electronic operations in the edge computing node 850. The processor 852 may access the non-transitory, machine-readable medium 860 over the interconnect 856. For instance, the non-transitory, machine-readable medium 860 may be embodied by devices described for the storage 858 or may include specific storage units such as optical disks, flash drives, or any number of other hardware devices. The non-transitory, machine-readable medium 860 may include instructions to direct the processor 852 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 882 on the processor 852 (separately, or in combination with the instructions 882 of the machine readable medium 860) may configure execution or operation of a trusted execution environment (TEE) 890. In an example, the TEE 890 operates as a protected area accessible to the processor 852 for secure execution of instructions and secure access to data. Various implementations of the TEE 890, and an accompanying secure area in the processor 852 or the memory 854 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 850 through the TEE 890 and the processor 852.

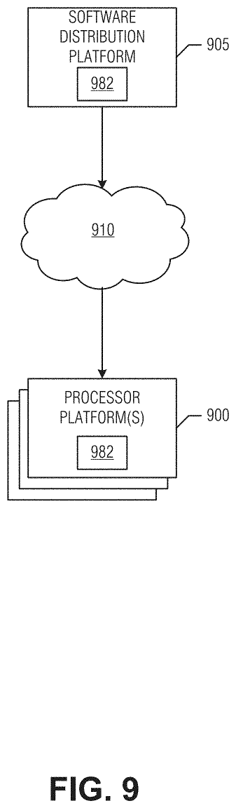

FIG. 9 illustrates an example software distribution platform 905 to distribute software, such as the example computer readable instructions 982 of FIG. 9, to one or more devices, such as example processor platform(s) 900 or connected edge devices. The example software distribution platform 905 may be implemented by any computer server, data facility, cloud service, etc., capable of storing and transmitting software to other computing devices (e.g., third parties, or connected edge devices). Example connected edge devices may be customers, clients, managing devices (e.g., servers), third parties (e.g., customers of an entity owning or operating the software distribution platform 905). Example connected edge devices may operate in commercial or home automation environments. In some examples, a third party is a developer, a seller, or a licensor of software such as the example computer readable instructions 982 of FIG. 9. The third parties may be consumers, users, retailers, OEMs, etc. that purchase or license the software for use or re-sale or sub-licensing. In some examples, distributed software causes display of one or more user interfaces (UIs) or graphical user interfaces (GUIs) to identify the one or more devices (e.g., connected edge devices) geographically or logically separated from each other (e.g., physically separated IoT devices chartered with the responsibility of water distribution control (e.g., pumps), electricity distribution control (e.g., relays), etc.).

In the illustrated example of FIG. 9, the software distribution platform 905 includes one or more servers and one or more storage devices. The storage devices store the computer readable instructions 982, which may correspond to the example computer readable instructions illustrated in the figures and described herein. The one or more servers of the example software distribution platform 905 are in communication with a network 910, which may correspond to any one or more of the Internet or any of the example networks described herein. In some examples, the one or more servers are responsive to requests to transmit the software to a requesting party as part of a commercial transaction. Payment for the delivery, sale or license of the software may be handled by the one or more servers of the software distribution platform or via a third-party payment entity. The servers enable purchasers or licensors to download the computer readable instructions 982 from the software distribution platform 905. For example, the software, which may correspond to the example computer readable instructions described herein, may be downloaded to the example processor platform(s) 900 (e.g., example connected edge devices), which are to execute the computer readable instructions 982 to implement the technique. In some examples, one or more servers of the software distribution platform 905 are communicatively connected to one or more security domains or security devices through which requests and transmissions of the example computer readable instructions 982 must pass. In some examples, one or more servers of the software distribution platform 905 periodically offer, transmit, or force updates to the software (e.g., the example computer readable instructions 982 of FIG. 9) to ensure improvements, patches, updates, etc. are distributed and applied to the software at the end user devices.

In the illustrated example of FIG. 9, the computer readable instructions 982 are stored on storage devices of the software distribution platform 905 in a particular format. A format of computer readable instructions includes, but is not limited to a particular code language (e.g., Java, JavaScript, Python, C, C#, SQL, HTML, etc.), or a particular code state (e.g., uncompiled code (e.g., ASCII), interpreted code, linked code, executable code (e.g., a binary), etc.). In some examples, the computer readable instructions 982 stored in the software distribution platform 905 are in a first format when transmitted to the example processor platform(s) 900. In some examples, the first format is an executable binary in which particular types of the processor platform(s) 900 can execute. However, in some examples, the first format is uncompiled code that requires one or more preparation tasks to transform the first format to a second format to enable execution on the example processor platform(s) 900. For instance, the receiving processor platform(s) 900 may need to compile the computer readable instructions 982 in the first format to generate executable code in a second format that is capable of being executed on the processor platform(s) 900. In still other examples, the first format is interpreted code that, upon reaching the processor platform(s) 900, is interpreted by an interpreter to facilitate execution of instructions.

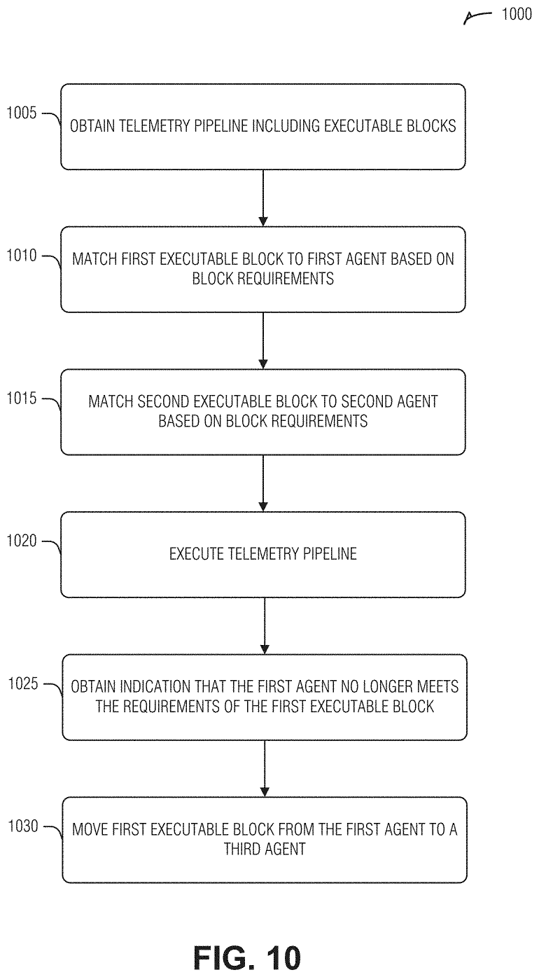

FIG. 10 illustrates a flow diagram of an example of a method 1000 for distributed telemetry platform, according to an embodiment. The operations of the method 1000 are implemented in computational hardware, such as that described above or below (e.g., processing circuitry).

At operation 1005, a telemetry pipeline comprising ordered executable blocks is obtained. Here, each executable block of the ordered executable block includes a requirements data structure. The ordered executable blocks pass information to each other to provide telemetry data when in operation. In an example, each of the executable blocks conforms to a same runtime constraint. In an example, the runtime constraint includes one or more of cryptographic signing, agent compatible run-time environment, single data format for inter-executable block communication, or execution policy limits.

At operation 1010, a first executable block of the telemetry pipeline is transmitted to a first agent based on first requirements in the requirements data structure for the first executable block. In an example, the first agent is an out-of-band telemetry agent implemented in hardware or firmware of a computing device.

In an example, the first executable block has multiple execution modes. Here, each execution mode has different requirements. In an example, the multiple execution modes are ordered. Here, a higher-order mode has greater requirements than a lower-order mode.

At operation 1015, a second executable block of the telemetry pipeline is transmitted to a second agent based on second requirements in the requirements data structure for the second executable block. In an example, the second agent is an in-band telemetry agent implemented in an operating system or application of a computing device.

At operation 1020, the telemetry pipeline is executed.

At operation 1025, an indication is obtained that the first agent does not meet the first requirements after execution of the telemetry pipeline has begun.

At operation 1030, the first executable block is moved from the first agent to a third agent in response to the indication. In an example, the third agent is a cloud agent.

In an example, the method 1000 is extended to include additional operations. The method 1000 includes receiving a notification that the second executable block was moved to a fourth agent by the second agent in response to the second agent failing to meet the second requirements.

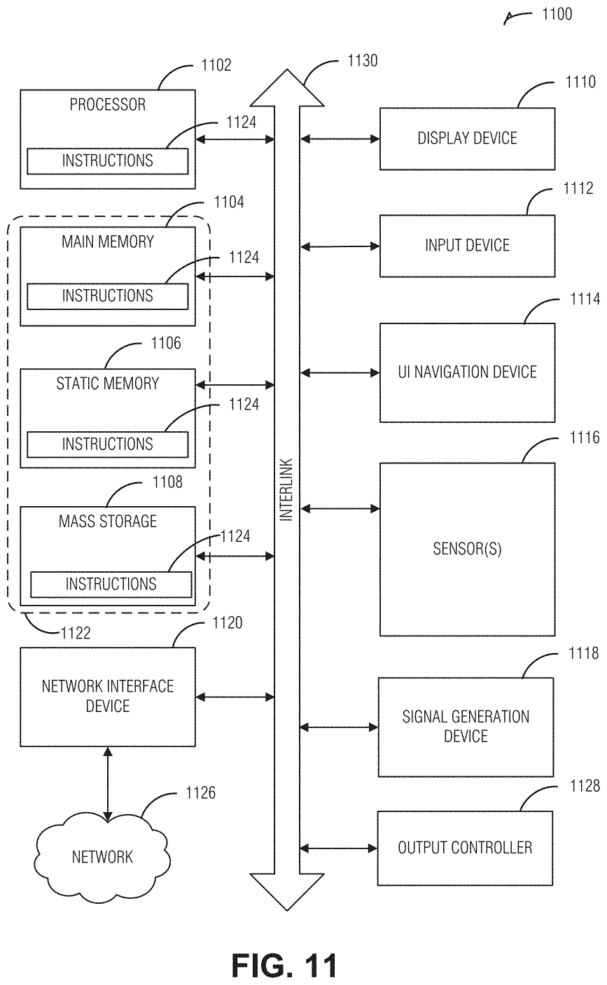

FIG. 11 illustrates a block diagram of an example machine 1100 upon which any one or more of the techniques (e.g., methodologies) discussed herein may perform. Examples, as described herein, may include, or may operate by, logic or a number of components, or mechanisms in the machine 1100. Circuitry (e.g., processing circuitry) is a collection of circuits implemented in tangible entities of the machine 1100 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1100 follow.

In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g,, computer system) 1100 may include a hardware processor 1102 (e.g., a central processing unit (CPU), a graphics processing unit (GPU), a hardware processor core, or any combination thereof), a main memory 1104, a static memory (e.g., memory or storage for firmware, microcode, a basic-input-output (BIOS), unified extensible firmware interface (UEFI), etc.) 1106, and mass storage 1108 (e.g., hard drives, tape drives, flash storage, or other block devices) some or all of which may communicate with each other via an interlink (e.g., bus) 1130. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1108, a signal generation device 1118 (e.g., a speaker), a network interface device 1120, and one or more sensors 1116, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1102, the main memory 1104, the static memory 1106, or the mass storage 1108 may be, or include, a machine readable medium 1122 on which is stored one or more sets of data structures or instructions 1124 (e.g., software) embodying or utilized by any one or more of the techniques or functions described herein. The instructions 1124 may also reside, completely or at least partially, within any of registers of the processor 1102, the main memory 1104, the static memory 1106, or the mass storage 1108 during execution thereof by the machine 1100. In an example, one or any combination of the hardware processor 1102, the main memory 1104, the static memory 1106, or the mass storage 1108 may constitute the machine readable media 1122. While the machine readable medium 1122 is illustrated as a single medium, the term “machine readable medium” may include a single medium or multiple media (e.g., a centralized or distributed database, or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1122 may be representative of the instructions 1124, such as instructions 1124 themselves or a format from which the instructions 1124 may be derived. This format from which the instructions 1124 may be derived may include source code, encoded instructions (e.g., in compressed or encrypted form), packaged instructions (e.g., split into multiple packages), or the like. The information representative of the instructions 1124 in the machine readable medium 1122 may be processed by processing circuitry into the instructions to implement any of the operations discussed herein. For example, deriving the instructions 1124 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1124.

In an example, the derivation of the instructions 1124 may include assembly, compilation, or interpretation of the information (e.g., by the processing circuitry) to create the instructions 1124 from some intermediate or preprocessed. format provided by the machine readable medium 1122. The information, when provided in multiple parts, may be combined, unpacked, and modified to create the instructions 1124. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1124 may be further transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a. packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., institute of Electrical and Electronics Engineers (IEEE) 802.11 family of standards known as Wi-Fi®, IEEE 802.16 family of standards known as WiMax®, IEEE 802.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software. A transmission medium is a machine readable medium.

### ADDITIONAL NOTES & EXAMPLES

Example 1 is an apparatus for a distributed telemetry platform, the apparatus comprising: machine readable media including instructions; and processing circuitry that, when in operation, is configured by the instructions to: obtain a telemetry pipeline comprising ordered executable blocks, each executable block of the ordered executable blocks including a requirements data structure, the ordered executable blocks passing information to each other to provide telemetry data when in operation; transmit a first executable block of the telemetry pipeline to a first agent based on first requirements in the requirements data structure for the first executable block; transmit a second executable block of the telemetry pipeline to a second agent based on second requirements in the requirements data structure for the second executable block; execute the telemetry pipeline; obtain an indication that the first agent does not meet the first requirements after execution of the telemetry pipeline has begun; and move the first executable block from the first agent to a third agent in response to the indication.

In Example 2, the subject matter of Example 1, wherein the first agent is an out-of-band telemetry agent implemented in hardware or firmware of a computing device.

In Example 3, the subject matter of any of Examples 1-2, wherein the second agent is an in-band telemetry agent implemented in an operating system or application of a computing device.

In Example 4, the subject matter of any of Examples 1-3, wherein the third agent is a cloud agent.

In Example 5, the subject matter of any of Examples 1-4, wherein each of the first and second executable blocks conform to a same runtime constraint.

In Example 6, the subject matter of Example 5, wherein the same runtime constraint includes one or more of cryptographic signing, agent compatible run-time environment, single data format for inter-executable block communication, or execution policy limits.

In Example 7, the subject matter of any of Examples 1-6, wherein the processing circuitry is configured by the instructions during operation to: receive a notification that the second executable block was moved to a fourth agent by the second agent in response to the second agent failing to meet the second requirements.

In Example 8, the subject matter of any of Examples 1-7, wherein the first executable block has multiple execution modes, wherein each execution mode has different requirements.

In Example 9, the subject matter of Example 8, wherein the multiple execution modes are ordered, and wherein a higher-order mode has greater requirements than a lower-order mode.

Example 10 is a method for a distributed telemetry platform, the method comprising: obtaining a telemetry pipeline comprising ordered executable blocks, each executable block of the ordered executable blocks including a requirements data structure, the ordered executable blocks passing information to each other to provide telemetry data when in operation; transmitting a first executable block of the telemetry pipeline to a first agent based on first requirements in the requirements data structure for the first executable block; transmitting a second executable block of the telemetry pipeline to a second agent based on second requirements in the requirements data structure for the second executable block; executing the telemetry pipeline; obtaining an indication that the first agent does not meet the first requirements after execution of the telemetry pipeline has begun; and moving the first executable block from the first agent to a third agent in response to the indication.

In Example 11, the subject matter of Example 10, wherein the first agent is an out-of-band telemetry agent implemented in hardware or firmware of a computing device.

In Example 12, the subject matter of any of Examples 10-11, wherein the second agent is an in-band telemetry agent implemented in an operating system or application of a computing device.

In Example 13, the subject matter of any of Examples 10-12, wherein the third agent is a cloud agent.

In Example 14, the subject matter of any of Examples 10-13, wherein each of the first and second executable blocks conform to a same runtime constraint.

In Example 15, the subject matter of Example 14, wherein the same runtime constraint includes one or more of cryptographic signing, agent compatible run-time environment, single data format for inter-executable block communication, or execution policy limits.

In Example 16, the subject matter of any of Examples 10-15, comprising: receiving a notification that the second executable block was moved to a fourth agent by the second agent in response to the second agent failing to meet the second requirements.

In Example 17, the subject matter of any of Examples 10-16, wherein the first executable block has multiple execution modes, wherein each execution mode has different requirements.

In Example 18, the subject matter of Example 17, wherein the multiple execution modes are ordered, and wherein a higher-order mode has greater requirements than a lower-order mode.

Example 19 is at least one machine readable medium including instructions for a distributed telemetry platform, the instructions, when executed by processing circuitry, cause the processing circuitry to perform operations comprising: obtaining a telemetry pipeline comprising ordered executable blocks, each executable block of the ordered executable blocks including a requirements data structure, the ordered executable blocks passing information to each other to provide telemetry data when in operation; transmitting a first executable block of the telemetry pipeline to a first agent based on first requirements in the requirements data structure for the first executable block; transmitting a second executable block of the telemetry pipeline to a second agent based on second requirements in the requirements data structure for the second executable block; executing the telemetry pipeline; obtaining an indication that the first agent does not meet the first requirements after execution of the telemetry pipeline has begun; and moving the first executable block from the first agent to a third agent in response to the indication.

In Example 20, the subject matter of Example 19, wherein the first agent is an out-of-band telemetry agent implemented in hardware or firmware of a computing device.

In Example 21, the subject matter of any of Examples 19-20, wherein the second agent is an in-band telemetry agent implemented in an operating system or application of a computing device.

In Example 22, the subject matter of any of Examples 19-21, wherein the third agent is a cloud agent.

In Example 23, the subject matter of any of Examples 19-22, wherein each of the first and second executable blocks conform to a same runtime constraint.

In Example 24, the subject matter of Example 23, wherein the same runtime constraint includes one or more of cryptographic signing, agent compatible run-time environment, single data format for inter-executable block communication, or execution policy limits.

In Example 25, the subject matter of any of Examples 19-24, wherein the operations comprise: receiving a notification that the second executable block was moved to a fourth agent by the second agent in response to the second agent failing to meet the second requirements.

In Example 26, the subject matter of any of Examples 19-25, wherein the first executable block has multiple execution modes, wherein each execution mode has different requirements.

In Example 27, the subject matter of Example 26, wherein the multiple execution modes are ordered, and wherein a higher-order mode has greater requirements than a lower-order mode.

Example 28 is a system for a distributed telemetry platform, the system comprising: means for obtaining a telemetry pipeline comprising ordered executable blocks, each executable block of the ordered executable blocks including a requirements data structure, the ordered executable blocks passing information to each other to provide telemetry data when in operation; means for transmitting a first executable block of the telemetry pipeline to a first agent based on first requirements in the requirements data structure for the first executable block; means for transmitting a second executable block of the telemetry pipeline to a second agent based on second requirements in the requirements data structure for the second executable block; means for executing the telemetry pipeline; means for obtaining an indication that the first agent does not meet the first requirements after execution of the telemetry pipeline has begun; and means for moving the first executable block from the first agent to a third agent in response to the indication.

In Example 29, the subject matter of Example 28, wherein the first agent is an out-of-band telemetry agent implemented in hardware or firmware of a computing device.

In Example 30, the subject matter of any of Examples 28-29, wherein the second agent is an in-band telemetry agent implemented in an operating system or application of a computing device.

In Example 31, the subject matter of any of Examples 28-30, wherein the third agent is a cloud agent.

In Example 32, the subject matter of any of Examples 28-31, wherein each of the first and second executable blocks conform to a same runtime constraint.

In Example 33, the subject matter of Example 32, wherein the same runtime constraint includes one or more of cryptographic signing, agent compatible run-time environment, single data format for inter-executable block communication, or execution policy limits.

In Example 34, the subject matter of any of Examples 28-33, comprising: means for receiving a notification that the second executable block was moved to a fourth agent by the second agent in response to the second agent failing to meet the second requirements.

In Example 35, the subject matter of any of Examples 28-34, wherein the first executable block has multiple execution modes, wherein each execution mode has different requirements.

In Example 36, the subject matter of Example 35, wherein the multiple execution modes are ordered, and wherein a higher-order mode has greater requirements than a lower-order mode.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. An apparatus for a distributed telemetry platform, the apparatus comprising:
machine readable media including instructions; and
processing circuitry that, when in operation, is configured by the instructions to:
obtain a telemetry pipeline comprising ordered executable blocks, each executable block of the ordered executable blocks including a requirements data structure, the ordered executable blocks passing information to each other to provide telemetry data when in operation;
transmit a first executable block of the telemetry pipeline to a first agent based on first requirements in the requirements data structure for the first executable block;
transmit a second executable block of the telemetry pipeline to a second agent based on second requirements in the requirements data structure for the second executable block;
execute the telemetry pipeline;
obtain an indication that the first agent does not meet the first requirements after execution of the telemetry pipeline has begun; and
move the first executable block from the first agent to a third agent in response to the indication.

2. The apparatus of claim 1, wherein the first agent is an out-of-band telemetry agent implemented in hardware or firmware of a computing device.

3. The apparatus of claim 1, wherein the second agent is an in-band telemetry agent implemented in an operating system or application of a computing device.

4. The apparatus of claim 1, wherein the third agent is a cloud agent.

5. The apparatus of claim 1, wherein each of the first and second executable blocks conform to a same runtime constraint.

6. The apparatus of claim 5, wherein the same runtime constraint includes one or more of cryptographic signing, agent compatible run-time environment, single data format for inter-executable block communication, or execution policy limits.

7. The apparatus of claim 1, wherein the processing circuitry is configured by the instructions during operation to:
receive a notification that the second executable block was moved to a fourth agent by the second agent in response to the second agent failing to meet the second requirements.

8. The apparatus of claim 1, wherein the first executable block has multiple execution modes, wherein each execution mode has different requirements.

9. The apparatus of claim 8, wherein the multiple execution modes are ordered, and wherein a higher-order mode has greater requirements than a lower-order mode.

10. A method for a distributed telemetry platform, the method comprising:
obtaining a telemetry pipeline comprising ordered executable blocks, each executable block of the ordered executable blocks including a requirements data structure;
transmitting a first executable block of the telemetry pipeline to a first agent based on first requirements in the requirements data structure for the first executable block;
transmitting a second executable block of the telemetry pipeline to a second agent based on second requirements in the requirements data structure for the second executable block;
executing the telemetry pipeline to obtain an indication that the first agent does not meet the first requirements after execution of the telemetry pipeline has begun; and
moving the first executable block from the first agent to a third agent in response to the indication.

11. The method of claim 10, wherein the first agent is an out-of-band telemetry agent implemented in hardware or firmware of a computing device.

12. The method of claim 10, wherein the second agent is an in-band telemetry agent implemented in an operating system or application of a computing device.

13. The method of claim 10, wherein the third agent is a cloud agent.

14. The method of claim 10, wherein each of the first and second executable blocks conform to a same runtime constraint.

15. The method of claim 14, wherein the same runtime constraint includes one or more of cryptographic signing, agent compatible run-time environment, single data format for inter-executable block communication, or execution policy limits.

16. At least one non-transitory machine readable medium including instructions for a distributed telemetry platform, the instructions, when executed by processing circuitry, cause the processing circuitry to perform operations comprising:
obtaining a telemetry pipeline comprising ordered executable blocks, each executable block of the ordered executable blocks including a requirements data structure, the ordered executable blocks passing information to each other to provide telemetry data when in operation;
transmitting a first executable block of the telemetry pipeline to a first agent based on first requirements in the requirements data structure for the first executable block;
transmitting a second executable block of the telemetry pipeline to a second agent based on second requirements in the requirements data structure for the second executable block;
executing the telemetry pipeline;
obtaining an indication that the first agent does not meet the first requirements after execution of the telemetry pipeline has begun; and
moving the first executable block from the first agent to a third agent in response to the indication.

17. The at least one non-transitory machine readable medium of claim 16, wherein the first agent is an out-of-band telemetry agent implemented in hardware or firmware of a computing device.

18. The at least one non-transitory machine readable medium of claim 16, wherein the second agent is an in-band telemetry agent implemented in an operating system or application of a computing device.

19. The at least one non-transitory machine readable medium of claim 16, wherein the third agent is a cloud agent.

20. The at least one non-transitory machine readable medium of claim 16, wherein each of the first and second executable blocks conform to a same runtime constraint.

21. The at least one non-transitory machine readable medium of claim 20, wherein the same runtime constraint includes one or more of cryptographic signing, agent compatible run-time environment, single data format for inter-executable block communication, or execution policy limits.

22. The at least one non-transitory machine readable medium of claim 16, wherein the operations comprise:
receiving a notification that the second executable block was moved to a fourth agent by the second agent in response to the second agent failing to meet the second requirements.

23. The at least one non-transitory machine readable medium of claim 16, wherein the first executable block has multiple execution modes, wherein each execution mode has different requirements.

24. The at least one non-transitory machine readable medium of claim 23, wherein the multiple execution modes are ordered, and wherein a higher-order mode has greater requirements than a lower-order mode.
